(19) United States
(12) Patent Application Publication
(10) Pub. No.: US 2010/0182500 A1
(43) Pub. Date: Jul. 22, 2010

(54) IMAGE DISPLAY DEVICE, IMAGE DISPLAY METHOD AND IMAGE DISPLAY PROGRAM

(76) Inventors: Junichirou Ishii, Tokyo (JP); Masao Imai, Tokyo (JP); Daigo Miyasaka, Tokyo (JP); Fujio Okumura, Tokyo (JP)

Correspondence Address: Mr. Jackson Chen, 6535 N. STATE HWY 161, IRVING, TX, 75039, US

(21) Appl. No.: 12/664,245

(22) PCT Filed: Jun. 2, 2008
(86) PCT No.: PCT/JP2008/060126

§ 371 Date: Dec. 11, 2009

(30) Foreign Application Priority Data
Jun. 13, 2007 (JP) 2007-156226

(51) Int. Cl. H04N 7/01

(52) U.S. Cl. 348/441; 348/E07.003

(57) ABSTRACT

An image display device is provided with an image memory for storing a first image as a target secret image; a synthesizing section for time-multiplexing the stored first image and a second image obtained by reversely converting the luminance of the first image; and an image display section for displaying the time-multiplexed image. An optical shutter which transmits light at the time of displaying the first image is arranged to the synthesizing section. The image display device is also provided with a display characteristic detecting section which fetches information regarding to the display characteristics of the image display section, and an image converting section which converts the first image into the second image, based on the fetched display characteristics of the image display section. Thus, the image display device effectively shields image display from a third party, even when the display characteristics of the the image display section are changed.

### TECHNICAL FIELD

The present invention relates to an image display device and the like. More specifically, the present invention relates to an image display device, an image display method, and a display program thereof, which can present video contents to a specific user via an optical shutter.

### BACKGROUND ART

Flat panel displays such as liquid crystal displays and plasma displays are widely applied to devices from mobile devices such as portable telephones to large-scaled devices such as public displays. Most of those displays are developed by concentrating on the points such as wide viewing angles, high luminance, and high picture quality, and there has been a demand for devices which can provide displays that can be viewed from any angles beautifully and easily.

In the meantime, contents displayed on the displays contain materials that are desired to be kept away from others, such as secret information and private data. Now that it is growing to a ubiquitous-computing society in accordance with developments in information apparatuses, to keep the display contents away from others is an important issue even in public where unspecified people are around. In addition, even within an office, there are also cases where a person needs to handle secret information that is desired to be kept away from those passing through the back of the seat.

In portable telephones and the like, there are types that include a display where an optical shield plate (louver) is provided so that the display contents can be viewed only from a specific direction. However, the display can be viewed from the right behind, so that those types are not considered sufficient for keeping secrecy.

In order to overcome such issues, there is an “image display device” disclosed in Patent Document 1. This image display device provides an image (referred to as “secret image” hereinafter) that can be recognized only by those who wears eyeglasses by having viewers wear the glasses that are provided with an image selecting function, and shows another image (referred to as “public image” hereinafter) to the other people.

Specifically, in the image display device as in FIG. 16, an image input signal 111 is stored in an image information accumulating memory 112 for one frame by being regulated with a frame signal 113. Then, the image information is read out twice from the memory 121 at a double speed of frame cycle, and the signal read first is inputted to a synthesizing circuit 115 as a first image signal 114 that is compressed to one half. The image signal read next has its saturation and luminance inverse-converted from those of the first image signal 114 by a converting circuit 116, and it is inputted to the synthesizing circuit 115 as a second image signal 117 thereafter.

Therefore, the first image signal 114 and the second image signal 117 are alternately displayed on an image display section 118.

In the meantime, the frame signal 113 drives a shutter of an eyeglass shutter 121 by a shutter timing generating circuit 119 so as to drive the eyeglass shutter 121 in such a manner that the image based on the second image signal 117 is not viewed by the viewer.

With such structure and action, those who do not wear the eyeglasses come to view a gray image or a third image (public image), which is a synthesized image of the first image signal 111 and the second image signal 117 and is irrelevant to the first image signal 111, while those who wear the eyeglasses can view a desired image (secret image) that is based on the first image signal 111.

### Patent Document 1: Japanese Unexamined Patent Publication S63-312788

### DISCLOSURE OF THE INVENTION

### Problems to be Solved by the Invention

In a case where the signal value of the image transmitted to the display device is set as A(0≦A≦1), luminance I displayed on displays that are currently on the market generally can be expressed in a relation as follows.

I=L×A^{γ} (1)

Note here that L is the maximum luminance the display device can provide. The reason for being in such nonlinear relation is that the luminance characteristic of a phosphor of a cathode-ray tube exhibits the characteristic as in equation (1) with respect to the intensity of the electron beam radiated to the phosphor. Thus, for the symbol “γ” in equation (1), a value of 2.2 is set in the standard of NTSC according to the luminance characteristic of the phosphor.

Also, “γ” is adjusted to 2.2 for displays that are currently on the market including displays (liquid crystal displays, plasma displays, etc.) other than the cathode-ray tube type in order to satisfy this standard. That is, in the displays satisfying the NTSC standard, following conversion is executed on the signal value of the image.

I=L×A^{(2.2)} (2)

Thus, in an image input device such as a digital camera, following conversion is executed in advance when converting the luminance value of each pixel of a picked up image to an image signal, anticipating that conversion of equation (2) is executed when displaying the image on the display device.

A=(I/L)^{(1/2.2)} (3)

Therefore, it can be said that the image signal (pixel value) transmitted from a personal computer or the like to the display device is data obtained by executing inverse conversion of equation (2).

In the image display device shown in Patent Document 1 as a related technique, the first image signal 111 is cancelled by the second image signal 117 so that the first image signal 111 cannot be seen by those who do not wear the eyeglasses. At this time, in order to cancel the first image signal 111 on the image display device, the first image signal 111 and the second image signal 117 need to be cancelled on a luminance level. Therefore, the saturation and luminance converting circuit 116 generates the second image signal 117 on the image display device side by anticipating that the conversion of equation (2) is executed with γ=2.2.

However, recently, display devices other than the cathode-ray tube type, such as liquid crystal displays and plasma displays, have been developed. Most of those display devices other than the cathode-ray tube type are provided with a function which can adjust the display characteristic such as gamma curve (luminance characteristic for image signals in the image display device) in accordance with preference of the users (viewers) and types (presentation image, document, film, etc.) of images to be displayed.

In the image display device shown in Patent Document 1, if the display device side is set by the user to be in a condition other than γ=2.2, the first image signal 111 cannot be cancelled since the saturation and luminance converting circuit 116 generates the second image signal 117 with γ=2.2.

Therefore, when the display characteristic of the display device is changed in the case of the related technique described above, the first image signal 111 is viewed by those without the eyeglasses. Thus, there is an issue of deteriorating the secrecy of the first image signal 111.

An object of the present invention is to provide an image display device, an image display method, and a program thereof, which can effectively shield display of the first image described above for the third parties by corresponding to changes, even when the display characteristic in the display section of the display device is changed.

### Means for Solving the Problems

In order to achieve the foregoing object, the image display device according to the present invention is an image display device having a function which displays an inputted first image only to a specific user, and the image display device includes: an image synthesizing section which time-multiplexes the first image and a second image different from the first image; an image display section which displays the time-multiplexed image; a display characteristic detecting section which detects a display characteristic of the image display section; an image converting section which converts the first image to the second image based on the detected display characteristic; and an optical shutter which transmits light when the first image is displayed on the image display section upon receiving a signal from the image synthesizing section.

The image display method according to the present invention is an image display method which displays an inputted first image only to a specific user, and the image display method includes: an image synthesizing step which time-multiplexes the first image and a second image different from the first image; an image display step which displays the time-multiplexed image; a display characteristic detecting step which detects a display characteristic of the image display section; an image converting step which converts the first image to the second image based on the detected display characteristic; and an optical shutter operating step which transmits light when the first image is displayed on the image display section upon receiving a signal from the image synthesizing section.

The image display program according to the present invention is an image display program which executes a control for displaying an inputted first image only to a specific user, and the program causes a computer to execute: an image synthesizing function which time-multiplexes the first image and a second image different from the first image; an image display function which displays the time-multiplexed image; a display characteristic detecting function which detects a display characteristic of the image display section; an image converting function which converts the first image to the second image based on the detected display characteristic; and an optical shutter operating function which transmits light when the first image is displayed on the image display section upon receiving a signal from the image synthesizing section.

### EFFECT OF THE INVENTION

The present invention is designed to capture the changed display characteristic even when the display characteristic such as the gamma characteristic of the image display section is changed, to generate the second image obtained by executing prescribed conversion on the first image based thereupon, and to apply time-multiplexing in the image display section. Therefore, even if the display characteristic of the image display section is changed, viewers who look at the image display section without the optical shutter cannot recognize the first image. This makes it possible to keep the secrecy of the first image.

### BEST MODES FOR CARRYING OUT THE INVENTION

Exemplary embodiments of the invention will be described hereinafter by referring to the drawings.

### (Basic Structure)

In FIG. 1, an image display device 10 according to the exemplary embodiment includes: a frame memory 11 as an image memory for storing an inputted first image A1 as a target of a secret image; a synthesizing section (image synthesizing section) 12 which performs time-multiplexing of the first image A1 and a second image A2 that is an image (inverted image of the first image in this exemplary embodiment) which is obtained by applying prescribed conversion on the first image A1 that is stored in the frame memory (image memory) 11; and an image display section 13A which displays the images (multiplexed images) that are time-multiplexed by the image synthesizing section 12. Further, the image display device 10 includes an optical shutter 16. The optical shutter 16 is used when only the user observes the screen of the image display section 13A, and it is structured to transmit light at the timing where the first image A1 contained in the multiplexed image outputted from the image synthesizing section 12 is displayed on the image display section 13A.

Further, the image display device 10 is provided with: a display characteristic detecting section 14 which fetches information regarding the display characteristic of the image display section 13A described above; and an image converting section 15 which converts the first image A1 stored in the frame memory 11 into the above-described second image A2 based on the display characteristic of the image display section 13A fetched by the display characteristic detecting section 14. The display characteristic of the image display section 13A includes the gamma characteristic and the like. Note here that a display device main body 13 is formed with the image display section 13A and the display characteristic detecting section 14.

This makes it possible to capture the changed display characteristic even when the display characteristic such as the gamma characteristic of the image display section 13A is changed and to generate the inverted image (second image) A2 based thereupon. Therefore, even if the display characteristic of the image display section 13A is changed, those who see the image display section 13A without the optical shutter 16 cannot view the first image (secret image) A1. As a result, secrecy of the first image A1 can be secured.

When generating the second image A2 based on the display characteristic of the above-described image display section 13A, the above-described image converting section 15 generates the second image A2 in such a manner that the added result obtained by adding the luminance value of the first image A1 and the luminance value of the second image A2 turns out as another image that has no correlation with the first image A1 as a whole.

The luminance of the second image A2 generated by the image converting section 15 may be set as follows in terms of the relation with respect to the first image A1 described above, for example.

That is, when the luminance of each pixel displayed on the image display section 13A of the image display device 10 described above can be expressed as I=L×A^{(γ)}(in this case, I is the luminance of the image displayed on the image display section 13A, L is the maximum luminance that can be displayed on the image display section 13A, A is the signal value of the pixel, and γ is the gamma value according to the display characteristic of the image display section 13A), the image converting section 15 calculates each signal value A′ of the second image by using a following equation based on the display characteristic obtained by the display characteristic detecting section 14.

A′=(1−A^{(γ)})(^{1-γ)}

Further, when the second image A2 generated in the manner described above is displayed on the image display section 13A, the above-described optical shutter 16 is controlled by the above-described image synthesizing section 12 to block light by synchronizing with the display control action.

In the relation between the optical shutter 16 and the image display section 13A, the first image A1 that can be viewed only through the optical shutter 16 is expressed as a secret image, the image formed by the second image signal that cancels the first image signal is expressed as an inverted image, and the third image that can be viewed when the image display section 13A is viewed without the optical shutter is expressed as a public image. This third image is a gray image in a case where it is obtained by time-multiplexing the first image A1 and the second image (inverted image) A2. However, in a case where another image is also time-multiplexed in addition to the first image A1 and the second image A2 as will be described later, this another image is displayed as it is on an external display (display without the optical shutter) as the third image.

The optical shutter 16 is turned on (ON: transmits light) by synchronizing with the timing at which the first image (secret image) A1 is displayed on the image display section 13A, and turned oil (OFF: blocks light) by synchronizing with the timing at which the second image (inverted image) A2 is displayed on the image display section 13A. When the image display section 13A is viewed through the optical shutter 16, it is possible to view the first image (secret image) A1. However, when the image display section 13A is viewed without the optical shutter 16, the first image A1 is cancelled by the second image (inverted image) A2, so that the first image cannot be viewed.

Upon detecting that the display characteristic of the image to be displayed on the image display section 13A has been changed due to an operation of the user or by surrounding environments, for example, the display characteristic detecting section 14 notifies the image converting section 15 that the display characteristic has been changed.

Frequencies of detections and notifications may be changed depending on the required conditions such as the characteristic of the display device, manufacturing cost, degree of desired secrecy, and the like. For example, detection and notification may be conducted only when the characteristic is changed by an operation of the user, may be conducted at every specific time, every one frame, or every several seconds. Higher the frequency of notification is, the lower the possibility of having a risk of the first image (secret image) A1 being peeped.

In this case, the display characteristic of the image to be displayed on the image display section 13A is detected by a widely-used luminance sensor that is mounted to the display characteristic detecting section 14. This makes it possible to correspond to changes in the surrounding environments in real time. In the meantime, for the display characteristic, it is also possible to store the basic display characteristic of the image display section 13A to a memory that is provided in advance to the display characteristic detecting section 14, and to output the stored display characteristic to the above-described image converting section for a normal case.

### (Overall Actions)

Explanations will be provided by referring to FIG. 2. In FIG. 2, first, the first image A1 inputted to the image display device 10 from outside is stored in the image memory 11 as a target to be a secret image (step S101: a first image storing step). Then, for the first image A1 stored in the image memory 11, the image converting section 15 generates the second image A2 that is an inverted image of the first image A1 based on the display characteristic of the image display section provided to the image display section 13A of the image display device 10 (step S102: a second image generating step as an image converting step). Subsequently, the synthesizing section 12 synthesizes the second image A2 as the generated inverted image with the first image A1 by time-multiplexing (step S103: an image synthesizing step). A specific example of this synthesized image will be described later in detail.

The image time-multiplexed in this image synthesizing step is transmitted to the image display section 13A within the display device main body 13 from the synthesizing section 12, and image-displayed on the image display section 13A (step S104: an image displaying step). The optical shutter 16 transmits light by being controlled by the image synthesizing section 12 at the timing where the first image A1 is displayed on the image display section 13A (step S105: an optical shutter operating step).

In this case, on the image display section 13A, the synthesized image appears as a gray image, for example, in which the first image A1 is cancelled by the second image A2. Thereby, the user can see the first image (secret image) A1 via the optical shutter 16, while the third party having no optical shutter 16 recognize the gray image, for example, on the image display section 13A. This makes it possible to keep the confidential state of the first image A1.

Now, the above-described second image generating step (the image converting step) in step S102 shown in FIG. 2 will be described in detail.

As described above, this image converting step (the second image generating step) is executed between the first image storing step and the image synthesizing step, and it is provided as the step for converting the first image A1 to the second image (inverted image) A2 based on the display characteristic of the image display section 13A.

It is a feature of this image converting step (the second image generating step) to generate the second image A2 in such a manner that the added result that is obtained, for example, by mutually adding the luminance values of the pixels corresponding to those of the first image A1 turns out as another image that has no correlation with the first image A1 as a whole when generating the second image A2.

As a specific example, as disclosed in the explanation of the structure of the image display device 10, for example, when the luminance of each pixel displayed on the image display section 13A described above can be expressed as I=L×A^{(γ)} (in this case, I is the luminance of the image displayed on the image display section 13A, L is the maximum luminance that can be displayed on the image display section 13A, A is the signal value of the pixel, and γ is the gamma value according to the display characteristic of the image display section 13A), each signal value A′ of the second image A2 is calculated in the image converting step by using a following equation based on the display characteristic of the image display section 13A obtained by the display characteristic detecting section 14.

A′=(1×A^{(γ)})^{(1/γ)}

This arithmetic operation is executed by the image converting section 15 described above.

Next, the action of generating the second image (inverted image) A2 executed by the image converting section 15 will be described in detail.

In the image converting step, the image converting section 15 generates the second image A2 that is the inverted image of the first image (secret image) A1 based on the display characteristic detected by the display characteristic detecting section 14. Here, it is assumed that the image to be displayed on the image display section 13A is displayed with the gamma value of 2.2, for example. At this time, the image converting section 15 generates the inverted image (the second image) obtained by applying prescribed conversion on the first image so that the first image (secret image) A1 is cancelled, by anticipating that the image is displayed on the display device side under a condition of the gamma value 2.2. A specific calculation method of the pixel signal value is as follows.

First, a given pixel on the image display section 13A for displaying the first image (secret image) A1 is considered. Assuming that the signal value of this pixel is A(0≦A≦1), the luminance I displayed on the image display section 13A is expressed with the equation (2) mentioned above. In order to satisfy this standard, “γ” is adjusted to 2.2 for displays that are currently on the market including displays (liquid crystal displays, plasma displays, etc.) other than the cathode-ray tube type. That is, in the displays satisfying the NTSC standard, following conversion is executed on the signal value of the image.

I=L×A^{(2.2)} (2)

The signal value A′ of the corresponding pixel of the second image (inverted image) A2 may be set in such a manner that the luminance that is the sum of the luminance when displaying the pixel value A and the luminance displaying the signal value A′ becomes constant no matter what value the signal value A of the pixel of the first image (secret image) A1 may be. That is, the signal value A′ may be determined in such a manner that the average value of the luminance of the signal value A and that of the signal value A′ becomes a half the maximum luminance that can be displayed on the display device, i.e., to satisfy L/2.

Thus, the signal value A′ can be obtained by a following equation.

A′=(1×A^{2.2})^{(1/2.2)} (4)

Note here that equation (4) does not include the maximum luminance L of the image display section 13A. That is, the inverted image (the second image) A2 can be generated from the first image (secret image) A1 if the value of gamma γ of the image display section 13A is known.

The way of obtaining the signal value A′ of the pixel of the second image (the inverted image) A2 is not necessarily limited to the equation (4), and there are other methods as well. It is simply required to cancel the first image (the secret image) A1 by the inverted image so that the secret image A1 cannot be seen when the image display section 13A is viewed without the optical shutter 16. The image obtained by synthesizing the first image (secret image) A1 and the second image (inverted image) A2 may not necessarily be a gray image, as long as it is a synthesized display image that is completely irrelevant to the first image (secret image) A1.

The method mentioned earlier is a method which cancels the first image (secret image) A1 by the second image (inverted image) A2 so that gray on the whole screen is perceived chronically due to an integral effect of human visual sensation. With this method, however, when eyes are moved slightly, there are cases where the contour of the first image (the secret image) can be recognized faintly, for example, if the cycle of displaying the first image A1 is slower than the cycle of displaying the second image (the inverted image) A2 (this is the same for the opposite case).

However, the method described herein can reduce such phenomenon, and makes it difficult for the first image (the secret image) to be seen.

The first image (the secret image) A1 and the second image (the inverted image) A2 which is converted and generated by the image converting section 15 is time-multiplexed by each frame by the synthesizing section 12, and transmitted to the image display section 13A.

For the order of synthesizing the first image (the secret image) A1 and the second image (inverted image) A2 performed in the synthesizing section 12, the first linage A1 and the second image A2 may be synthesized alternately. Alternatively, the first image A1 may be displayed twice consecutively and the second image A2 may be displayed twice consecutively. That is, the number of displaying the secret image A1 needs to be the same as the number of displaying the second image A2 within a short time. If the numbers are different, either the secret image A1 or the inverted image A2 comes to be displayed more distinctively. Therefore, those who view the image display section 13A without the optical shutter 16 can faintly see the secret image A1, so that it is necessary to be careful.

Further, in a case where a great number of either the first images (the secret images) A1 or the second images (the inverted images) are consecutively displayed even if the numbers of displaying the images are the same, the first image A1 and the second image A2 are not integrated chronically when the frame frequency is low. Thus, flickers are perceived by those who view the image display section 13A without the optical shutter 16. Therefore, the first image A1 can also be viewed in such case, so that it is necessary to be careful.

In general, when one cycle shows a display of about 60 Hz provided that the display of the first image (the secret image) A1 and the second image (the inverted image) A2 is one cycle, the images are not perceived as flickers. Further, the first image A1 and the second image A2 are integrated chronically, so that those who do not use the optical shutter 16 cannot see the first image A1.

Therefore, when six images are displayed in one cycle in order of secret image→inverted image→inverted image→secret image→inverted image→secret image at a rate of the frequency 360 Hz for displaying one image, for example, the secret image A1 and the inverted image A2 are displayed in 1/60 seconds. Thus, flickers are not detected. In addition, since the secret image A1 and the inverted image A2 are displayed for the same number of times (three times each), so that the secret image is cancelled by the inverted image. Therefore, the secret image cannot be viewed when the image display section 13A is viewed without the optical shutter 16.

As described above, the optical shutter 16 is controlled to be ON when the secret image A1 is displayed and to be OFF when the inverted image A2 is displayed by synchronizing with the image displayed on the image display section 13A.

In the above-described case, the optical shutter 16 is controlled to be ON→OFF→OFF→ON→OFF→ON in every 1/360 second for the display order of secret image→inverted image→inverted image→secret image→inverted image→secret image. Thereby, the secret image A1 can be seen only when the display section is viewed via the optical shutter 16.

In order to have the optical shutter 16 synchronize with the display image, it is possible to employ a method which determines the order of synthesizing the secret image A1 and the inverted image A2 by the synthesizing section 12, and transmits a synchronous signal to the optical shutter 16 in accordance with the order. Alternatively, it is also possible to employ a method which transmits a flag showing whether the image is the secret image A1 or the inverted image A2 along with the image when transmitting the image from the synthesizing section 12 to the image display section 13A, and transmits a synchronous signal to the optical shutter 16 from the image display section 13A. Furthermore, if the synchronous signal is wiretapped, the optical shutter 16 is forged. Thus, the synchronous signal may be encoded on the transmission side in advance, and decoded on the optical shutter 16 side.

In FIG. 1, the frame memory 11, the image converting section 15, and the synthesizing section 12 may be designed to be formed by a video card or the like loaded on a personal computer. Alternatively, it is also possible to employ a structure which stores image signals on a memory of a personal computer, executes image conversion and image synthesis on software, and transmits the synthesized image to the image display section 13A from the video card or the like.

Furthermore, as shown in FIG. 3, the frame memory 11, the image converting section 15, and the synthesizing section 12 may be provided within the display device main body 13. In this case, when an image desired to be displayed as a secret image is transmitted to the display device main body 13 from a personal computer or the like, an inverted image is generated within the display device main body 13. Therefore, it is unnecessary to use a personal computer used exclusively for achieving the concealed display, so that it has such an advantage that the concealed display can be achieved by connecting to an arbitrary personal computer.

### (Regarding Third Image)

As shown in FIG. 4, it is also possible to create a synthesized image that is in a multiplexed structure obtained by adding a third image (public image) which is completely different from the secret image (the first image) A1 in addition to the secret image (the first image) A1 and the inverted image (the second image) A2.

That is, when time-multiplexing the second image A2 that is the inverted image of the first image A1, a third image as a public image that is inputted accordingly from outside may be time-multiplexed therewith. In that case, this multiplexing synthesis is executed in the image synthesizing step of step S103 described above.

That is, in the case of FIG. 4, a frame memory 17 as an image memory for storing the third image A3 as a public image inputted from outside is provided on the input side of the synthesizing section 12 described above, and the synthesizing section 12 has a function which time-multiplexes each of the first to third images and outputs the synthesized image to be displayed on the image display section 13A. At the same time, the optical shutter 16 provided to the synthesizing section 12 is structured to be operated to transmit light by being controlled by the synthesizing section 12, when the first image A1 is displayed on the image display section 13A.

In other words, the inputted third image (the public image) is stored in the second memory 17, and the synthesizing section time-multiplexes the secret image, the inverted image, and the public image by each screen, and transmits the multiplexed image to the image display section 13A.

Further, in this exemplary embodiment, the optical shutter 16 described above is structured to operate by being controlled by the image synthesizing section 12 and to function to block light by synchronizing with the display action when the second and third images are displayed on the image display section 13A. That is, in this case, the optical shutter 16 is controlled to be ON when the secret image is displayed and to be OFF when the inverted image and the public image are displayed by synchronizing with the image displayed on the image display section 13A. Other structures and the operational effects thereof are the same as the case of FIG. 1 described above.

Furthermore, in this case, when looking at the image display section 13A via the optical shutter 16, the secret image (the first image) A1 can be viewed. However, when the image display section 13A is viewed without the optical shutter 16, the secret image (the first image) A1 is cancelled by the inverted image A2, and only the public image (the third image) A3 is perceived.

In a case where the secret image A1 is an image (character or the like) that is supplementally added to the public image A3, there is no problem even if the public image A3 is viewed via the optical shutter 16. Thus, the optical shutter may be controlled to be ON when the public image A3 is displayed. This provides such an advantage that the brightness of the image via the optical shutter 16 can be doubled compared to the case where the optical shutter is controlled to be OFF when the public image A3 is displayed.

### (Regarding Display Characteristic of Image Display Section)

In the above-described exemplary embodiment, to generate the inverted image (the second image) A2 of the secret image (the first image) A1 by the image converting section 15 takes up an important position due to the structure of the exemplary embodiment.

In that case, generation of the inverted image (the second image) A2 in this exemplary embodiment is designed to be executed based on the display characteristic of the image display section 13A as described above.

Regarding the display characteristic of the image display section 13A, for example, the cathode-ray tune type and the liquid crystal panel that is a flat panel exhibit different characteristics.

Therefore, in order to generate the inverted image (the second image) A2 effectively for any forms of image display sections 13A, it is necessary to know the display characteristic of the corresponding image display section 13A in advance. This exemplary embodiment has made it possible. This will be described in detail hereinafter.

With flat panels such as liquid crystal panels and plasma panels, this exemplary embodiment is capable of variably setting the display characteristic from outside as desired. In this case, when variably setting the display characteristic of the image display section 13A from outside, it is executed in the image converting step (the second image generating step) of step S102 shown in FIG. 2.

Further, most of the display characteristics of the image display section 13A changes due to changes in the surrounding environments. In that case, this exemplary embodiment is designed to detect characteristic information regarding the display characteristic at the timing where the image is displayed on the image display section 13A by using a luminance sensor or a temperature sensor provided in advance as will be described later, and to specify the display characteristic by the above-described display characteristic detecting section 14 based thereupon.

### Detection of Display Characteristic (1)

First, with this exemplary embodiment, as shown in FIG. 5, an input device 24 for setting or changing the display characteristic of the image display section 13A is provided to the image display section 13A. At the same time, the display characteristic detecting section 14 has a function which fetches the image display characteristic inputted from outside to the image display section 13A to be used for the image converting section.

With this, the display characteristic detecting section 14 sends the fetched display characteristic to the image converting section 15 for generating an inverted image. Thereby, the image converting section 15 executes generation of the inverted image (the second image) A2 of the first image A1 described above (step S102: the image converting step). Other structures of FIG. 5 are the same as those of the FIG. 1 described above.

### Detection of Display Characteristic (2)

In FIG. 5, the above-described display characteristic detecting section 14 acquires the characteristic information for the display characteristic from the input device 24, and stores conversion table data that is calculated in advance by corresponding to the characteristic information to a memory 14a that is provided separately. Further, the display characteristic detecting section 14 transmits the conversion table data stored in the memory 14a to the image converting section 15. In this case, the input device 24 is structured to input the characteristic information for specifying the display characteristic of the image display section 13A to the display section main body 13 from outside.

The image converting section 15 generates the second image A2 based on the conversion table data (step S102: the image converting step). Other structures of FIG. 5 are the same as those of FIG. 1 described above.

### Detection of Display Characteristic (3)

Further, in FIG. 5, the display characteristic detecting section 14 is provided in advance with the memory 14a to which the gamma value and the characteristic data corresponding to the display characteristic of the image display section 13A is stored, and also provided with a gamma table output function which, when the gamma value and the like are inputted from the input device 24, immediately takes out the gamma value and the corresponding gamma table from the memory 14a and outputs those to the image converting section 15.

In this case, the input device 24 inputs the characteristic information of the gamma value and the like for specifying the display characteristic of the image display section 13A to the display section main body 13 from outside.

The image converting section 15 takes in the gamma value and the value of the corresponding gamma table sent from the display characteristic detection section 14 as the display characteristic, and generates the second image A2 based thereupon (step S102: the image converting step).

This will be described in more details.

In the exemplary embodiment, the display characteristic detecting section 14 assumes a case where the user changes or sets a change of the display characteristic of the image display section 13A via the input device 24 such as a push-button provided to the display section main body 13. In that case, upon detecting the change of the display characteristic based on the input information from the input device 24, the display characteristic detecting section 14 transmits the changed gamma value, the value of the color temperature, or the differential value to the image converting section 15.

In that case, the display characteristic detection section 14 may separately prepare a memory 14b to which gamma characteristic data (see FIG. 6) which is acquired in advance is stored, read out the gamma data corresponding to the changed gamma data from the memory 14b, and may transmit a gamma curve of the entire gradations or a part of the gradations.

For example, it is assumed that the user inputs a value to change the gamma value from 2.2 to 2.1 via the input device 24. Upon detecting the change, the display characteristic detecting section 14 transmits data of “gamma value=2.1” to the image converting section 15. At this time, only the gamma value may simply be transmitted, or the differential value with respect to the gamma value before the change (in this case, “2.1−2.2=0.1”, i.e., data of “gamma value changed difference=−0.1”) may be transmitted.

Alternatively, the gamma data of the entire gradations for the corresponding gamma value (see the chart of FIG. 6: the values within the chart show the gamma curve of each gradation in the image display section 13A) may be transmitted from the memory 14b to which the gamma characteristic data is stored in advance, or a secret image signal value-inverted image signal value conversion table data (see the chart of FIG. 7: the values within the chart show the gradation values of the inverted image with respect to each of the gradation values of the secret image) for generating the inverted image based on the gamma value.

With the second and fourth methods described above, the conversion table data for each gradation is transmitted. Thus, the data to be transmitted is in a large amount, and a memory for saving the table is required additionally. However, those methods can generate the inverted image for accurately canceling the image display of the secret image even with the image display section 13A whose gamma characteristic does not correspond strictly to “2.2 power rule” or “2.1 power rule”.

Further, it is not essential to transmit the gamma data of the entire gradations or the conversion table. For example, in a case where 8 bit=256 gradations, a total of nine pieces of data each with 32 gradations may be transmitted. Further, the data may not have to be transmitted at equal intervals. The gradations near the sharper curve part may be transmitted more, and the gradations near the flat curve part may be transmitted less. In that case, the conversion table of the gradations other than the conversion points transmitted intermittently is complemented by the image converting section 15. This makes it possible to reduce the data to be transmitted, so that the processing can be executed promptly. As described, even if the display characteristic is changed by the user, the inverted image can be generated effectively by corresponding to the change. Therefore, the secret image cannot be viewed without the optical shutter.

### Detection of Display Characteristic (4)

Other examples of the case of detecting the display characteristic of the image display section 13A in the exemplary embodiment are shown in FIG. 8-FIG. 11. All the examples are structured to have a luminance sensor 26, 26A, 26B, or 26C to detect the luminance information regarding the display characteristic of the image display section 13A, and to send the luminance information to the display characteristic detecting section 14 (step S102: the image converting step).

### (Case of FIG. 8)

In this case, the luminance sensor 26 for detecting the brightness of the image displayed on the image display section 13A is provided to the display characteristic detecting section 14, so that it is possible to detect the change of the display characteristic of the image based on chronological changes in the peripheral temperature and the light source in real time. In FIG. 8, other structures are the same as those of the cases of FIG. 1 and FIG. 5 described above.

In the meantime, as other more specific structural examples using the luminance sensor, there are the cases as in FIG. 9 and FIG. 10 in which the display section main body 13 is a DLP (Digital Light Processing) projector or a liquid crystal projector, and the luminance sensor 26A or 26B is provided in the vicinity of a projecting section 18 for projecting an image or in the vicinity of a screen 13B. The luminance sensor 26A or 26B may be of any types as long as it is possible to detect the relative luminance of the image. For example, a photodiode or a CCD camera may be used.

### (Case of FIG. 9)

In the case of FIG. 9, the image display section 13A is structured to include the screen 13B which displays a multiplexed image transmitted from the synthesizing section 12A and the image projecting section 18 which projects the multiplexed image to the screen 13B. Further, the luminance sensor 26A which detects the luminance by synchronizing with the projection timing of a test image projected on a test image display section 13Ba provided at a part of the screen 13B is provided to the display characteristic detecting section 14. Furthermore, the display characteristic detecting section 14 is structured to have a function which detects and specifies the display characteristic of the screen 13B based on the luminance of the test image detected by the luminance sensor 26A. In FIG. 9, reference numeral 14c indicates a memory which stores the luminance information of the test image detected by the luminance sensor 26A. Other structures of FIG. 9 are the same as those of FIG. 1 or FIG. 5 described above.

For a specific action of the content shown in FIG. 9, i.e., the action regarding detection of the display characteristic of the image display section 13A, an image of specific brightness (all-gray image of (R, G, B)=(127, 127, 127) with same image signal value within a whole part of the test image display section 13Ba) is displayed for one to several frames on the several-pixel corners in a part on the test image display section 13Ba where no obstruction is caused for the viewer to see that image, such as at the edges (upper right, lower right, upper left, lower left) of the displayed image by every specific time, for example, and the luminance of the image displayed on the test image display section 13Ba is measured by the luminance sensor 26A by synchronizing with the displayed image.

At this time, more accurate display characteristic of the image display section 13A can be obtained not by measuring only one kind of brightness but by measuring several kinds of brightness, e.g., “four kinds such as (R, G, B)=(0, 0, 0), (R, G, B)=(63, 63, 63), (R, G, B)=(127, 127, 127), (R, G, B)=(255, 255, 255)” by every specific time, or by measuring the brightness separately for R, G, and B.

### (Case of FIG. 10)

In the case of FIG. 10, the image display section 13A is structured to include the screen 13B which displays a multiplexed image transmitted from the synthesizing section 12A and the image projecting section 18 which projects the multiplexed image to the screen 13B. Further, the luminance sensor 26B which detects the luminance by synchronizing with the projection timing of a test image projected on the entire screen 13B is provided to the display characteristic detecting section 14.

Furthermore, the display characteristic detecting section 14 is structured to have a function which detects and specifies the display characteristic of the screen 13B based on the luminance of the test image detected by the luminance sensor 26B. Reference numeral 14d indicates a memory which stores the luminance information of the test image detected by the luminance sensor 26B. Other structures of FIG. 10 are the same as those of FIG. 1 or FIG. 5 described above.

Regarding the action of FIG. 10, the test image is displayed on the whole screen once in several to several tens of frames. Further, when displaying the test image, the optical shutter 16 is controlled to be OFF. When the image display section 13A is viewed via the optical shutter 16, the secret image can be viewed without recognizing the test image. When the display section 13A is viewed without the optical shutter 16, the viewer momentarily perceives the display of the image with luminance other than the all-gray image “(R, G, B)=(127, 127, 127)” when the test image is displayed. However, it is not the secret image that is viewed, so that the secrecy of the secret image can still be secured.

### (Test Image Display Method of FIG. 9 and FIG. 10)

As a test image drive-display method of FIG. 9 and FIG. 10, two test images of (R, G, B)=(0, 0, 0) and (R, G, B)=(255, 255, 255) may be displayed continuously as shown in FIG. 11, for example. In this case, when the image display section 13A is viewed without the optical shutter 16, the two test images are integrated in terms of time and viewed as (R, G, B)=(127, 127, 127) due to the cancel effect of the secret image A1 and the inverted image A2 since the solid image of (R, G, B)=(127, 127, 127) is viewed originally. Therefore, even for those who view the display section (the screen 13B) without the optical shutter, the display characteristic can be measured while not recognizing that the luminance measurement is conducted at all.

Note here that the two test images are not limited to those mentioned above but may be (R, G, B)=63, 63, 63) and (R, G, B)=(191, 191, 191) or may be (R, G, B)=(0, 255, 0) and (R, G, B)=(255, 0, 255).

As described above, however, since the signal value and the luminance are in a nonlinear relation, the image cannot exactly be seen as display of (R, G, B)=127, 127, 127) even if two images of (R, G, B)=(63, 63, 63) and (R, G, B)=(191, 191, 191) are displayed or integrated in terms of time. However, it is only a momentary event and displayed is an image whose luminance is not so different from the image of (R, G, B)=(127, 127, 127). Therefore, flickers of the image are not a big issue for the viewer even when the display section (the screen 13B) is viewed without the optical shutter 16.

Furthermore, the image signal values of the two test images may be set by utilizing the already-measured display characteristic data in such a manner that the luminance becomes (R, G, B)=(127, 127, 127) when the two test images are displayed in terms of time.

For example, provided that it is known in advance that the display characteristic at the previous measurement is the characteristic with which the obtained luminance is the same as (R, G, B)=(127, 127, 127) when displaying the (R, G, B)=(63, 63, 63) and (R, G, B)=(247, 247, 247) in terms of time, (R, G, B)=63, 63, 63) and (R, G, B)=(247, 247, 247) may be displayed instead of (R, G, B)=(63, 63, 63) and (R, G, B)=(191, 191, 191) in terms of time.

Since the previously measured data is referred, the display characteristic may differ from that of the previously measured one. Thus, the luminance may not necessarily be (R, G, B)=(127, 127, 127) precisely. However, the error may not be so large when the measurement interval is short. That is, flickers are not to be perceived at an instant of the measurement. This method can prevent a phenomenon where the viewer who looks at the image display section 13A without the optical shutter 16 momentarily perceives the image with the luminance different from (R, G, B)=(127, 127, 127).

### Detection of Display Characteristic (5)

Still other examples of the case of detecting the display characteristic of the image display section 13A in the exemplary embodiment are shown in FIG. 12 and FIG. 13. Both of the examples are structured to have the luminance sensor 26C to detect the luminance information regarding the display characteristic of the image display section 13A, and to send the luminance information to the display characteristic detecting section 14 (step S102: the image converting step).

### (Case of FIG. 12)

First, the image display section 13A is formed with a flat panel such as a liquid crystal panel or a plasma display panel. At the same time, a test image display section 13Aa is provided in a part of the image display section 13A by being extended from one side of the image display region in an area that cannot be seen from the viewer. Further, the luminance sensor 26C for measuring the luminance is provided by corresponding to the test image display section 13Aa. The display characteristic detecting section 14 described above has a function which detects and specifies the display characteristic of the image display section 13A based on the luminance of the test image detected by the luminance sensor 26C. Other structures of FIG. 12 are the same as those of FIG. 1 or FIG. 5 described above.

In the case of FIG. 12 or as another specific example, the image display section 13A may also be formed with an LCD (Liquid Crystal Display) or a PDP (Plasma Display Panel).

As a specific example of such case, it is also possible to employ a method with which: the test image display section 13Aa is provided at a part (in a bezel or the like) that cannot be seen from the viewer as described above; a test image is displayed on the test image display section 13Aa by another mechanism from that of the display section 13A which displays the secret image A1 and the inverted image A2; and the luminance is measured by the luminance sensor 26C. For the frequency of measurements, the measurement may be executed by synchronizing with a frame, may be executed by every several milliseconds, or may be executed only when there is an operation conducted by the user to change the display characteristic.

In the case of the above-described structure, the test image is not displayed within the screen viewed by the viewer, unlike the structures shown in FIG. 9 or FIG. 10. Thus, there is no problem generated for the viewing no matter what kinds of test images are displayed.

### (Case of FIG. 13)

In the case of FIG. 13, a test image display region for displaying a test image for specifying the display characteristic of the image display section 13A is provided at least in a part of the image display section 13A, and the luminance sensor 26C for measuring the luminance is provided by corresponding to the test image display region. Further, the display characteristic detecting section 14 described above has a function which detects and specifies the display characteristic of the image display section 13A based on the luminance of the test image detected by the luminance sensor 26C. Other structures of FIG. 13 are the same as those of FIG. 1 or FIG. 5 described above.

The luminance sensor 26C may be formed by a small luminance sensor such as a photodiode provided at an edge of the display device as shown in FIG. 13. In this case, unlike the example shown in FIG. 12, the display characteristic is measured by using the screen viewed by the viewer. Thus, as described in the explanations of FIG. 9 or FIG. 10, it is necessary to elaborate a method for displaying the image so as not to cause inconveniences to the viewer.

### Detection of Display Characteristic (6)

Still another example of the case when detecting the display characteristic of the image display section 13A in the exemplary embodiment will be described. This case is structured to measure the temperature of a light source of an image projecting section which projects an image to the screen 13B, or, structured to form the display section 13A by a liquid crystal panel and measure at least the temperature of the liquid crystal panel or the temperature of a backlight used for image display, and transmit the results thereof as the characteristic information of the display characteristic (for converting the image) to the display characteristic detecting section 14 described above (step S102: the image converting step).

### (Case of Modification Example of FIG. 10)

In the specific example of FIG. 10, described is the case where the luminance of the screen 13B is measured by using the luminance sensor 26C, and the display characteristic is detected based thereupon. In the meantime, the modification example is a case where the temperature of the light source of the image projecting section for projecting the image to the screen 13B is measured, and the display characteristic of the screen 13B is specified from the change in the characteristic information corresponding to the temperature information. That is, the image display section 13A described above is structured to include the screen 13B which displays a multiplexed image from the synthesizing section 12 and the image projecting section 18 which projects the multiplexed image to the screen 13B.

Further, the display characteristic detecting section 14 has a function which transmits to the image converting section 15, as characteristic information regarding the display characteristic, a temperature-luminance conversion table corresponding to the detected temperature stored to a memory 14c that is provided in advance in accordance with temperature information from the temperature sensor 26B which is provided to the light source of the image projecting section 18 for measuring the temperature of the light source. Furthermore, the image converting section 15 is structured to generate the second image A2 based on the display characteristic that is specified from the values of the temperature-luminance conversion table. Other structures are the same as those of the case of FIG. 1 or FIG. 5 described above.

### (Case of FIG. 14)

In FIG. 14, the above-described image display section 13A is formed with a liquid crystal (LCD) panel. Further, the, display characteristic detecting section 14 is provided with a temperature sensor 27 which measures at least the temperature of the liquid crystal panel 13A of the image display section 13A or the temperature of a backlight 13D used for image display. In the specific example of FIG. 14, it is structured to measure the temperature of the LCD panel 13a or the temperature of the backlight 13D in a switching manner.

Further, the display characteristic detecting section 14 has a function which receives an input of the detected temperature from the above-described temperature sensor 27 and transmits to the image converting section 15 a temperature-luminance conversion table corresponding to the detected temperature, which is stored in advance, as the characteristic information regarding the display characteristic. In this case, the temperature-luminance conversion table corresponding to the detected temperature is stored in a memory 14A that is provided to the display characteristic detecting section 14 as the data measured in advance. In practice, the above-described temperature-luminance conversion table is measured and stored in advance at the time of manufacturing the entire image display device.

The display characteristic detecting section 14 specifies the display characteristic by referring to the temperature measured by the temperature sensor 27 and the table data installed into the temperature-luminance conversion table stored in the memory 14A, and informs the display characteristic to the above-described image converting section 15. By storing the gamma value-luminance conversion table along with the temperature-luminance conversion table as the table data, it is also possible to correspond to the change in the gamma value made by the user in addition to corresponding to the change in the temperature.

Further, the image converting section 15 is structured to generate the second image A2 based on the display characteristic that is specified from the values of the temperature-luminance conversion table. Other structures are the same as those of the case of FIG. 1 or FIG. 5 described above.

As described, the use of the exemplary embodiments such as the contents shown in FIG. 1-FIG. 5, FIG. 8-FIG. 10, and FIG. 12-FIG. 14 makes it possible to detect the changes by the display characteristic detecting section 14 even when the display characteristic such as the gamma value or the color temperature of the image display device is changed, and to generate the inverted image based thereupon. Therefore, even if the display characteristic of the image display section 13A is changed, the first image A1 can never be seen when the image display section 13A is viewed without the optical shutter 16. Thus, secrecy of the first image A1 can be kept securely.

For executing the image display method of the image display device according to the above-described exemplary embodiments, a plurality of execution steps have been disclosed. However, the execution contents of each step thereof may be put into a program to have it executed by a computer.

This provides such an advantage that the execution contents of each step can be processed more promptly and with high accuracy.

While the exemplary embodiments of the invention have been described above by referring to the specific examples thereof, the present invention is not limited to those exemplary embodiments. It is to be understood that various kinds of modifications and corrections occurred to those skilled in the art are to be included therewith without departing from the scope of the appended claims of the present invention.

An image display device according to another exemplary embodiment of the invention is an image display device having a function which displays an inputted first image only to a specific user, and the image display device includes: an image synthesizing section which time-multiplexes the first image and a second image different from the first image; an image display section which displays the time-multiplexed image; a display characteristic detecting section which detects a display characteristic of the image display section; an image converting section which converts the first image to the second image based on the detected display characteristic; and an optical shutter which transmits light when the first image is displayed on the image display section upon receiving a signal from the image synthesizing section.

In the image display device, when generating the second image that is generated based on the display characteristic of the image display section, the image converting section may generate the second image in such a manner that an image obtained as a result of mutually adding luminance values of pixels corresponding to those of the first image becomes another image that has no correlation to the first image as a whole.

In the image display device, when the luminance of each pixel displayed on the image display section can be expressed as I=L×A^{γ)}(I is the luminance of the image displayed on the image display section, L is the maximum luminance that can be displayed on the image display section, A is a signal value of the pixel, and γ is a gamma value according to the display characteristic of the image display section), the image converting section may calculate each pixel value A′ of the second image by using a following equation based on the display characteristic obtained by the display characteristic detecting section.

A′=(1−A^{(γ)})^{(1/γ)}

In the image display device, the optical shutter may have a function which, when the second image is displayed on the image display section, blocks light by synchronizing with the display action.

In the image display device, a memory for storing a third image that is another image inputted from outside may be provided on the input side of the synthesizing section, and the synthesizing section may time-multiplex each of the first to third images and output the multiplexed image to the image display section for display and may be provided with an optical shutter which functions to transmit light correspondingly when the first image is displayed on the image display section.

In the image display device, when the second and third images are displayed on the image display section, the optical shutter may function to block the light by synchronizing with the display action.

In the image display device, an input device which sets or changes the display characteristic of the image display section from outside may be provided to the image display section, and the display characteristic detecting section may have a function which fetches the image display characteristic inputted from outside to the image display section for the image converting section.

The image display device may be structured in such a manner that: an input device which inputs characteristic information for specifying the display characteristic of the image display section may be provided; the display characteristic detecting section may have a function which acquires the characteristic information inputted from the input device and stores conversion table data calculated in advance based on the characteristic information to a memory that is provided separately; and a function which transmits the conversion table data stored in the memory to the image converting section, and the image converting section may generate the second image based on the conversion able data.

The image display device may be structured in such a manner that: an input device which inputs characteristic information such as a gamma value for specifying the display characteristic of the image display section to the image display section is provided; the display characteristic detecting section is provided in advance with a memory to which a gamma value corresponding to the display characteristic of the image display section and characteristic data thereof are stored, and has a gamma table output function which, when the gamma value and the like are inputted from the input device, immediately takes out the gamma value and a gamma table corresponding thereto from the memory and outputs those to the image converting section; and the image converting section takes the gamma value transmitted from the display characteristic detecting section and the value of the gamma table corresponding thereto as the display characteristic, and generates the second image based thereupon.

The image display device may be structured in such a manner that: a test image display region for displaying a test image for specifying the display characteristic of the image display section is provided at least in a part of the image display section, and a luminance sensor for measuring the luminance is provided by corresponding to the test image display region; and the display characteristic detecting section has a function which detects and specifies the display characteristic of the image display section based on the luminance of the test image detected by the luminance sensor.

The image display device may be structured in such a manner that: the image display section is formed with a flat panel such as a liquid crystal panel or a plasma display panel; and the test image display section is provided in a part of the image display section by being extended from one side of the image display region in an area that cannot be seen from the viewer.

The image display device may be structured in such a manner that: the image display section includes a screen which displays a multiplexed image transmitted from the synthesizing section and an image projecting section which projects the multiplexed image to the screen; the display characteristic detecting section includes a luminance sensor which detects the luminance by synchronizing with projection timing of a test image projected on a part of or a whole part of the screen; and the display characteristic detecting section detects and specifies the display characteristic of the image display section based on the luminance of the test image detected by the luminance sensor.

The image display device may be structured in such a manner that: the optical shutter has a function whish blocks light by synchronizing with display timing of the test image by being controlled by the synthesizing section; and the luminance sensor has a function which acquires luminance of the test image by synchronizing with the display timing of the test image by being controlled by the display characteristic detecting section.

The image display device may be structured in such a manner that: the synthesizing section has a function which displays at least two pieces of the test images in short time during which the images are not perceived by human eyes; and the two test images are set to be in luminance that is equal to a maximum luminance value that can be displayed on the image display section when the luminance of the corresponding images is added mutually.

The image display device may be structured in such a manner that: the image display section includes a screen which displays a multiplexed image from the synthesizing section and an image projecting section which projects the multiplexed image to the screen; the display characteristic detecting section has a function which transmits to the image converting section, as characteristic information regarding the display characteristic, a pre-stored temperature-luminance conversion table corresponding to the detected temperature in accordance with temperature information from a temperature sensor which is provided to a light source of the image projecting section for measuring the temperature of the light source; and the image converting section generates the second image based on the display characteristic that is specified from the values of the temperature-luminance conversion table.

The image display device may be structured in such a manner that: the image display section is formed with a liquid crystal panel; the display characteristic detecting section has a function which receives an input of the detected temperature from the temperature sensor which measures at least the temperature of the liquid crystal panel of the image display section or the temperature of a backlight used for image display, and transmits a pre-stored temperature-luminance conversion table corresponding to the detected temperature to the image converting section as the characteristic information regarding the display characteristic; and the image converting section generates the second image based on the display characteristic that is specified from the values of the temperature-luminance conversion table.

An image display method according to another exemplary embodiment of the invention is an image display method which displays an inputted first image only to a specific user, and the image display method includes: an image synthesizing step which time-multiplexes the first image and a second image different from the first image; an image display step which displays the time-multiplexed image; a display characteristic detecting step which detects a display characteristic of the image display section; an image converting step which converts the first image to the second image based on the detected display characteristic; and an optical shutter operating step which transmits light when the first image is displayed on the image display section upon receiving a signal from the image synthesizing section.

In the image display method, the image converting step may generate the second image in such a manner that an image obtained as a result of mutually adding luminance values of pixels corresponding to those of the first image becomes another image that has no correlation to the first image as a whole when generating the second image that is generated based on the display characteristic of the image display section.

In the image display method, when the luminance of each pixel displayed on the image display section can be expressed as I=L×A^{(γ)}(I is the luminance of the image displayed on the image display section, L is the maximum luminance that can be displayed on the image display section, A is a signal value of the pixel, and γ is a gamma value according to the display characteristic of the image display section), the image converting step may calculate each pixel value A′ of the second image by using a following equation based on the display characteristic of the image display section obtained by the display characteristic detecting section.

A′=(1×A^{(γ)})^{(1-γ)}

In the image display method, when time-multiplexing the first image with a second image that is obtained by applying prescribed conversion to the first image, the image synthesizing step may time-multiplex a third image that is inputted from outside accordingly.

In the image display method, the image converting step may fetch the display characteristic inputted from outside for the image display section as the display characteristic required for generating the second image.

In the image display method, the image converting step may include: a characteristic information acquiring step which fetches characteristic information for specifying the display characteristic of the image display section inputted from outside; and a conversion table data extracting step which extracts conversion table data corresponding to the characteristic information from a memory that is separately prepared and stored in advance and fetches the data as the display characteristic required when generating the second image.

In the image display method, the image converting step may include: a characteristic information input step which inputs, from outside, characteristic information such as a gamma value for specifying the display characteristic of the image display section; and a display characteristic fetching step which extracts a gamma table value corresponding to the characteristic information such as the gamma value from a memory that is stored in advance and fetches the value as the display characteristic required when generating the second image.

In the image display method, the image converting step may include: a luminance detecting step which detects luminance of each pixel via a luminance sensor from a test image that is displayed on a part of the image display section; and a display characteristic specifying step which detects and specifies the display characteristic of the image display section based on the detected luminance.

In the image display method, the image converting step may include: a step which detects luminance of a test image projected on a part or a whole part of a multiplexed image displaying screen by synchronizing with projecting timing of the test image; and a step which specifies the display characteristic of the image display section based on the detected luminance of the test image.

In the image display method, the image display step may include a step which displays the images time-multiplexed in the image synthesizing step on a screen by the image projecting section; and the image converting step may include a light source temperature fetching step which fetches light source temperature information from a temperature sensor that is provided to a light source of the image projecting section, and a step which extracts a temperature-luminance conversion table corresponding to the detected temperature calculated and stored in advance to a memory by corresponding to a change in the light source temperature from the memory, and specifies the display characteristic based thereupon.

In the image display method, the image converting step may include, when the image display section is formed with a liquid crystal panel: a step which fetches a detected temperature from a temperature sensor that is provided for measuring at least temperature of the liquid crystal panel or the temperature of a backlight used for image display; and a step which extracts, as the display characteristic, a temperature-luminance conversion table that is stored in a memory provided in advance by corresponding to the detected temperature from the temperature sensor.

An image display program according to another exemplary embodiment of the invention is an image display program which executes a control for displaying an inputted first image only to a specific user, and the program causes a computer to execute: an image synthesizing function which time-multiplexes the first image and a second image different from the first image; an image display function which displays the time-multiplexed image; a display characteristic detecting function which detects a display characteristic of the image display section; an image converting function which converts the first image to the second image based on the detected display characteristic; and an optical shutter operating function which transmits light when the first image is displayed on the image display section upon receiving a signal from the image synthesizing section.

With the image display program, the image conversion processing function may generate the second image in such a manner that an image obtained as a result of mutually adding luminance values of pixels corresponding to those of the first image becomes another image that has no correlation to the first image as a whole when generating the second image that is generated based on the display characteristic of the image display section.

With the image display program, when the luminance of each pixel displayed on the image display section can be expressed as I=L×A^{(γ)}(I is the luminance of the image displayed on the image display section, L is the maximum luminance that can be displayed on the image display section, A is a signal value of the pixel, and γ is a gamma value according to the display characteristic of the image display section), the image conversion processing function may calculate each pixel value A′ of the second image by using a following equation based on the display characteristic of the image display section obtained by the display characteristic detecting section.

A′=(1−A^{(γ)})^{(1-γ)}

With the image display program, when time-multiplexing the first image with a second image that is obtained by applying prescribed conversion to the first image, the image synthesizing processing function may time-multiplex a third image that is inputted from outside accordingly.

With the image display program, the image conversion processing function may fetch the display characteristic inputted from outside for the image display section as the display characteristic required for generating the second image.

With the image display program, the image conversion processing function may include: characteristic information acquiring processing which fetches characteristic information for specifying the display characteristic of the image display section inputted from outside; and conversion table data extracting processing which extracts conversion table data corresponding to the characteristic information from a memory that is prepared in advance and fetches the data as the display characteristic required when generating the second image.

With the image display program, the image conversion processing function may include: characteristic information input processing which inputs, from outside, characteristic information such as a gamma value for specifying the display characteristic of the image display section; and display characteristic fetching processing which extracts a gamma table value corresponding to the characteristic information such as the gamma value from a memory that is stored in advance and fetches the value as the display characteristic required when generating the second image.

With the image display program, the image conversion processing function may include: luminance detecting processing which detects luminance of each pixel via a luminance sensor from a test image that is displayed on a part of the image display section; and display characteristic specifying processing which detects and specifies the display characteristic of the image display section based on the detected luminance.

With the image display program, the image conversion processing function may include: processing which detects luminance of a test image projected on a part or a whole part of a multiplexed image displaying screen by synchronizing with projecting timing of the test image; and processing which specifies the display characteristic of the image display section based on the detected luminance of the test image.

With the image display method, the image display processing function may include processing which displays the images time-multiplexed by the image synthesizing processing function on a screen by drive-controlling the image projecting section; and the image conversion processing function may include light source temperature fetching processing which fetches light source temperature information from a temperature sensor that is provided to a light source of the image projecting section, and processing which extracts a temperature-luminance conversion table corresponding to the detected temperature calculated and stored in advance to a memory by corresponding to a change in the light source temperature from the memory, and specifies the display characteristic based thereupon.

With the image display program, the image conversion processing function may include, when the image display section is formed with a liquid crystal panel: processing which fetches a detected temperature from a temperature sensor that is provided for measuring at least the temperature of the liquid crystal panel or the temperature of a backlight used for image display; and processing which extracts, as the display characteristic, a temperature-luminance conversion table that is stored in a memory provided in advance by corresponding to the detected temperature from the temperature sensor.

When the image display device in the exemplary embodiment of the invention is built as a software program, the program is recorded on a recording medium and handled as a subject of commercial transactions.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2007-156226 filed on Jun. 13, 2007, and the disclosure thereof is hereby incorporated by reference in its entirety.

### INDUSTRIAL APPLICABILITY

The present invention is capable of securely keeping the secrecy of the first image (secret image) A1 even when there is a change in the surrounding environments, so that it is possible to effectively correspond to diversity in information gathering.

### BRIEF DESCRIPTION OF THE DRAWINGS

FIG. 1 is a block diagram showing an exemplary embodiment of the invention;

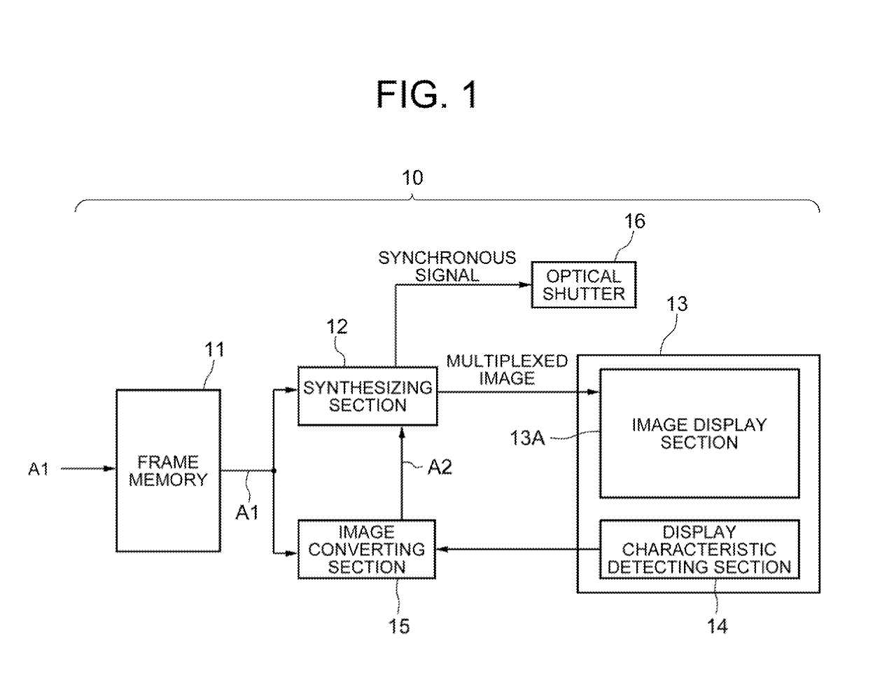

FIG. 2 is a flowchart showing actions of the exemplary embodiment disclosed in FIG. 1;

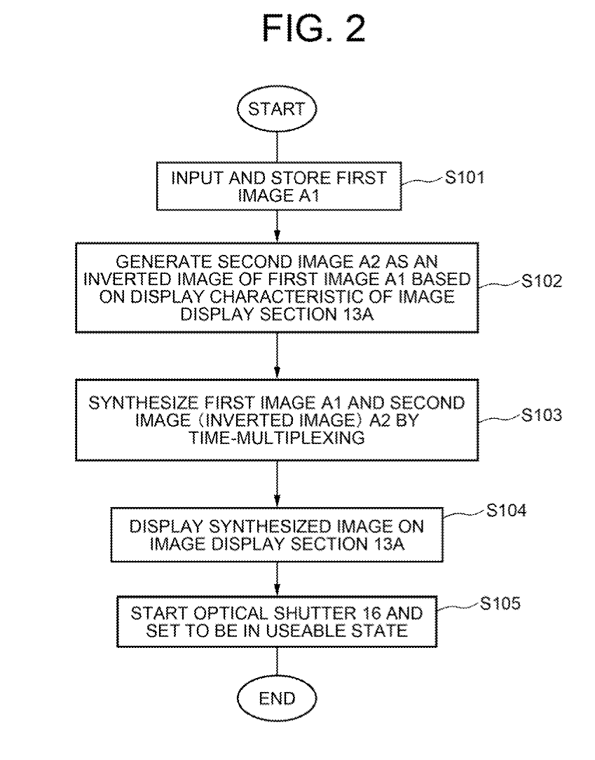

FIG. 3 is a block diagram showing a modification example of the exemplary embodiment disclosed in FIG. 1;

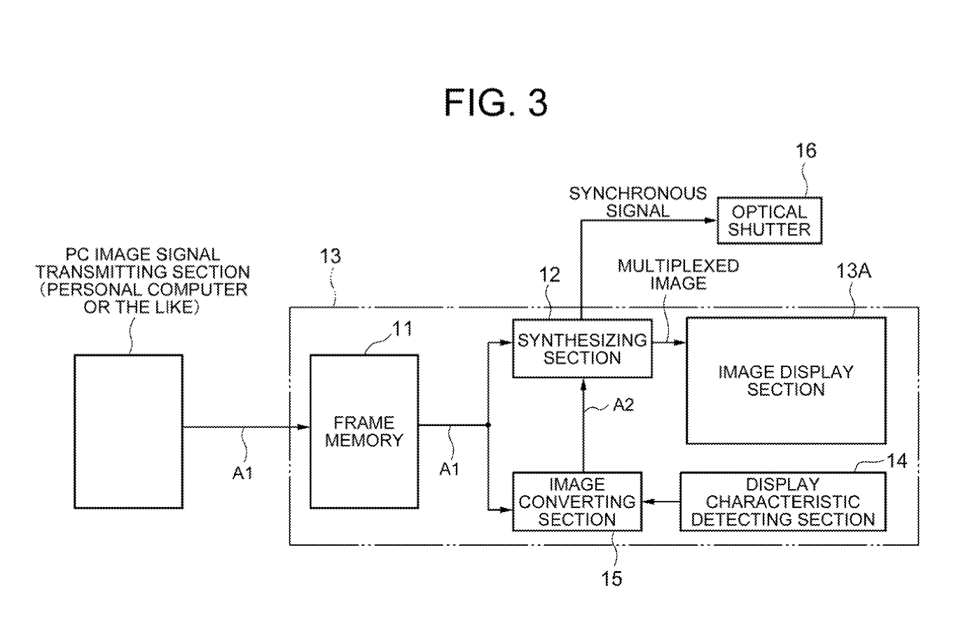

FIG. 4 is a block diagram showing an applied example of the exemplary embodiment disclosed in FIG. 1, which is a case where a third image is time-multiplexed to be displayed;

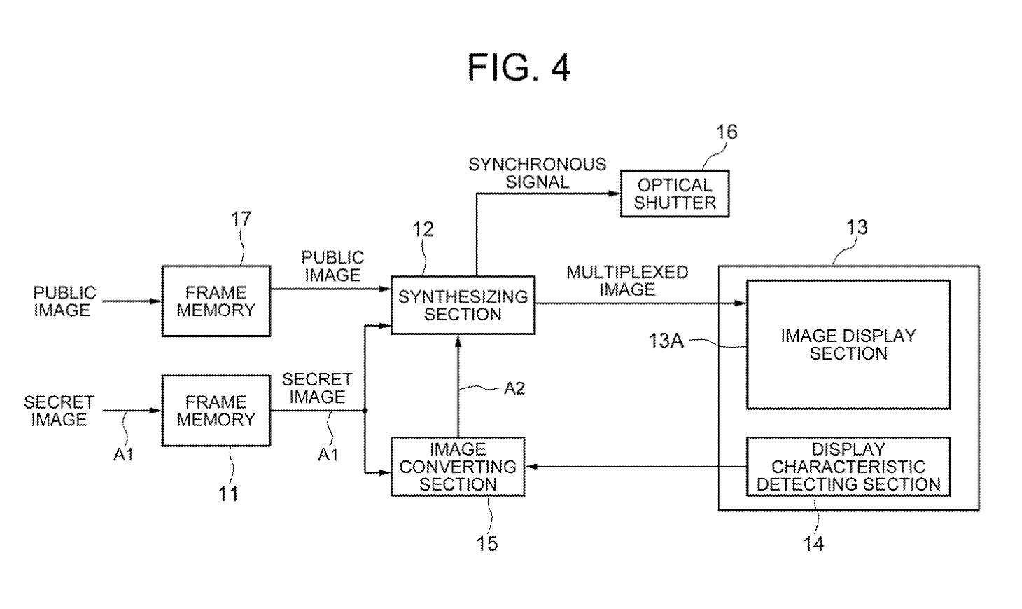

FIG. 5 is an explanatory diagram showing a structural example of a case where the display characteristic of an image display section of the exemplary embodiment disclosed in FIG. 1 is changed;

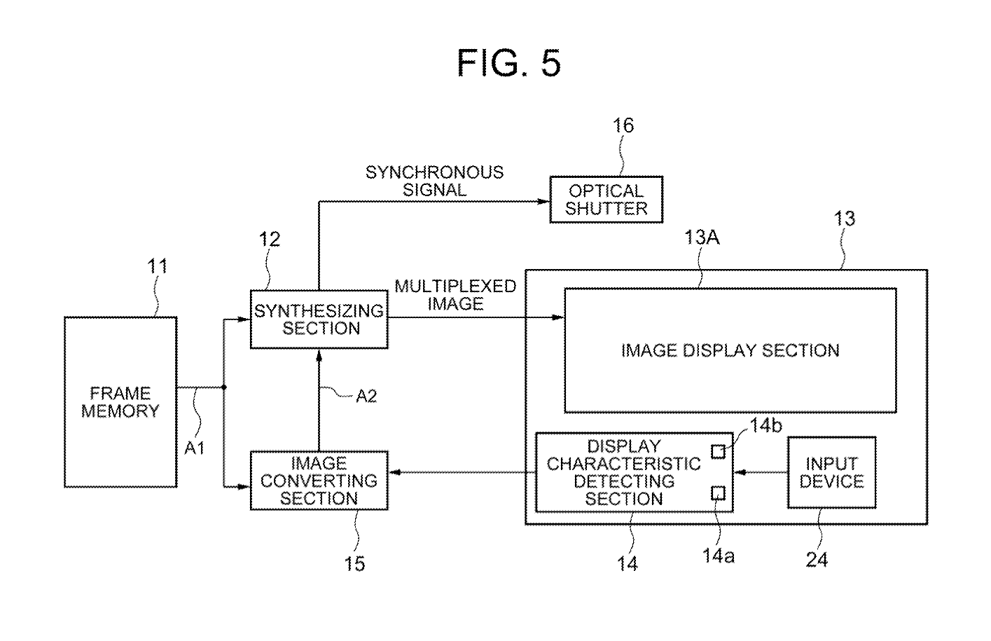

FIG. 6 is a chart showing an example of a gamma conversion table stored in a memory of a display characteristic detecting section shown in FIG. 5;

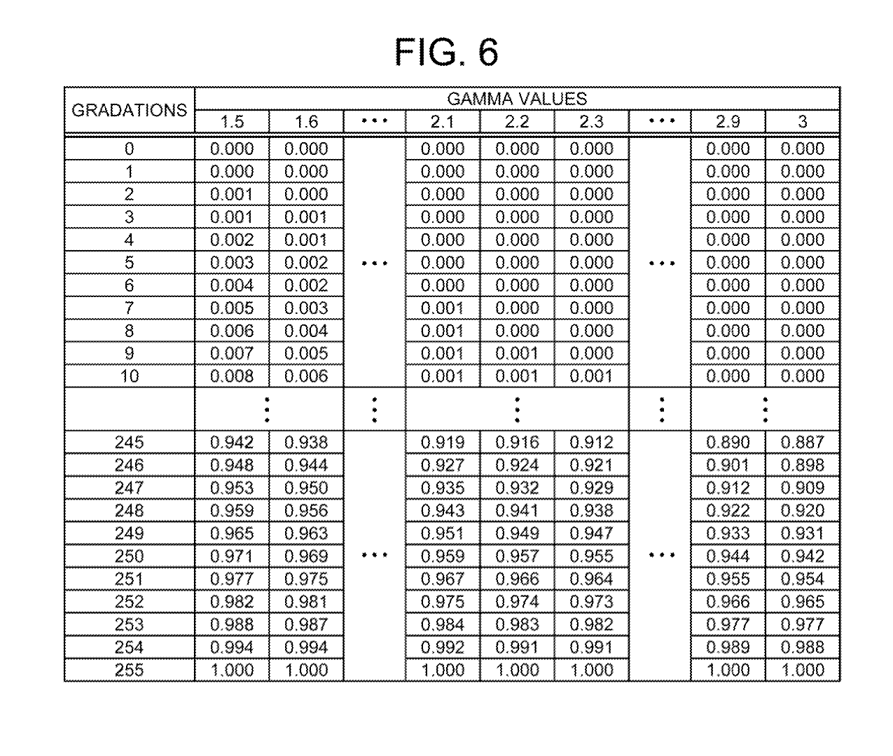

FIG. 7 is a chart showing an example of a secret image signal value-inverted image signal value table stored in the memory of the display characteristic detecting section shown in FIG. 5;

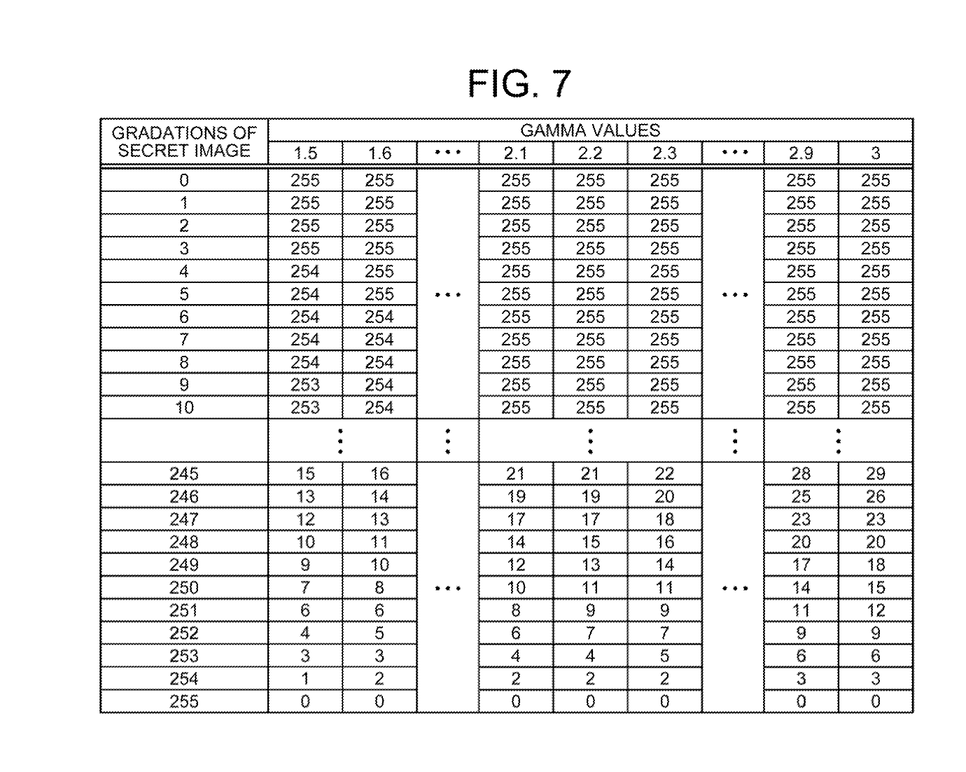

FIG. 8 is a specific block diagram showing an example of a case where the display characteristic of the image display section of the exemplary embodiment disclosed in FIG. 1 is measured in real time from the actual image display section;

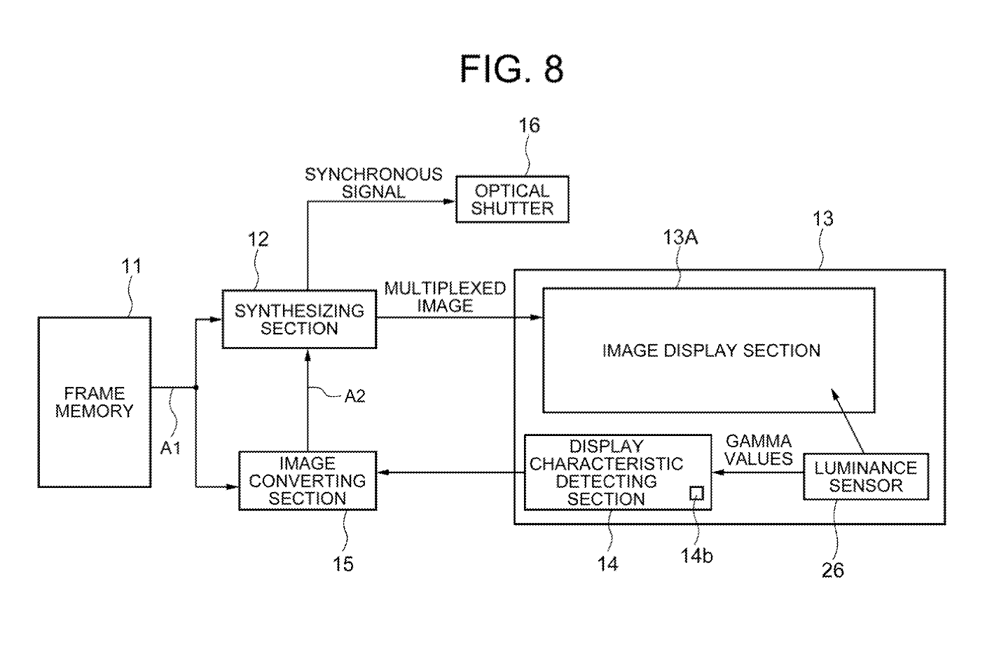

FIG. 9 is a block diagram showing a modification example (a case where the image display section is formed with a screen) of FIG. 8;

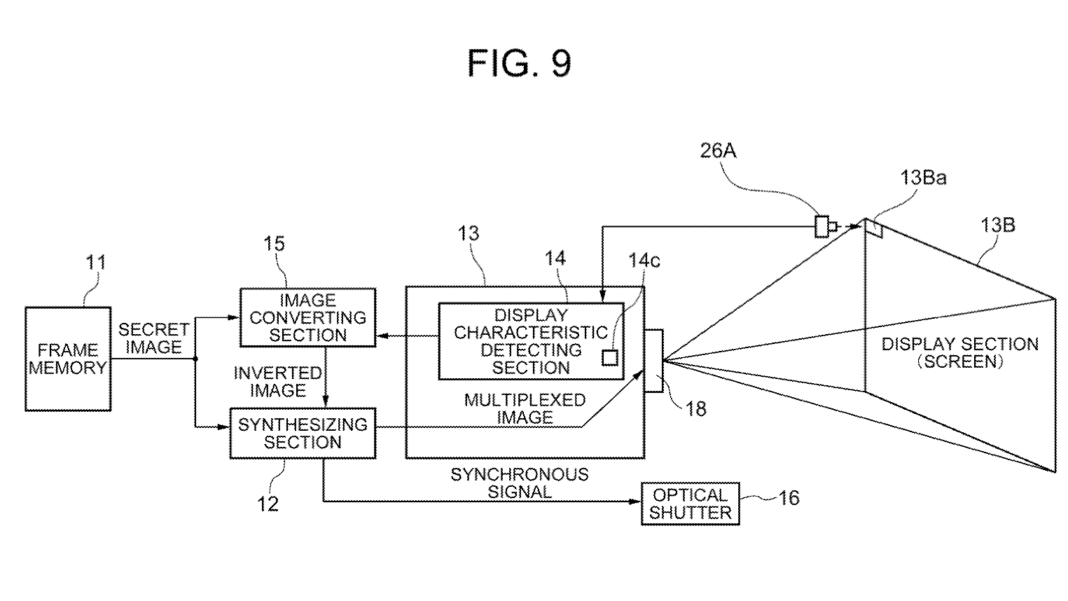

FIG. 10 is a block diagram showing another modification example (a case where the image display section is formed with a screen) of FIG. 8;

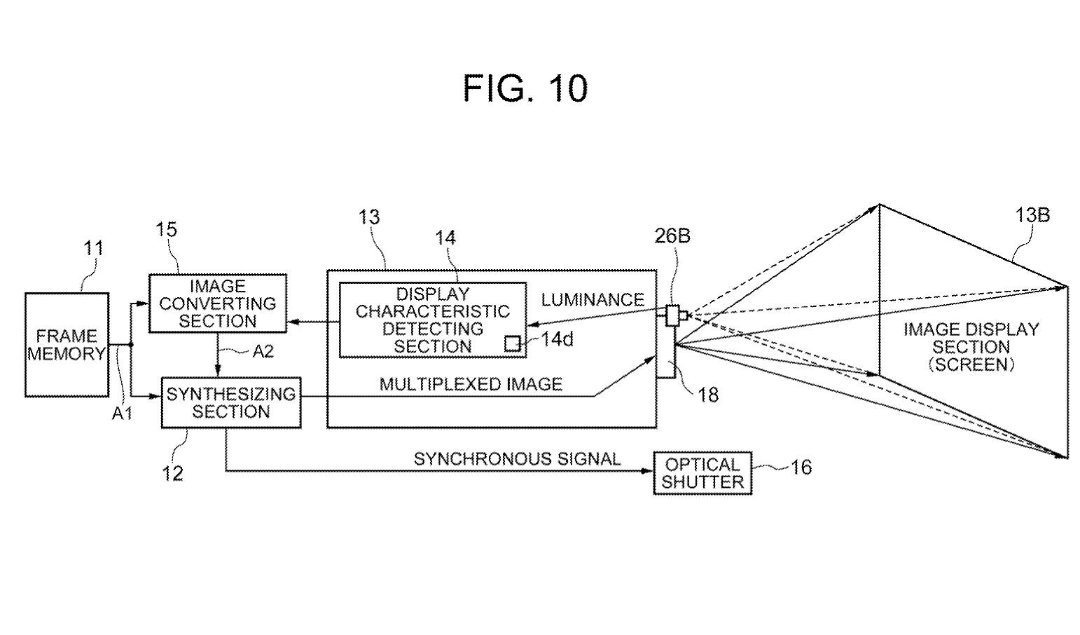

FIG. 11 is an explanatory diagram showing an example of display order of test images in the case of FIG. 10;

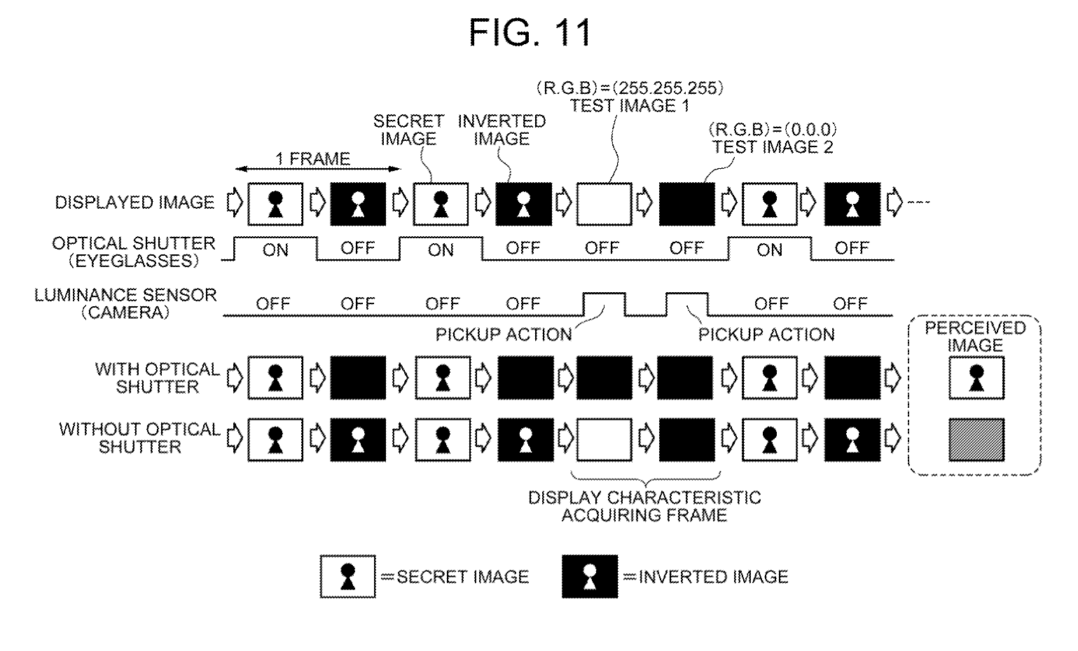

FIG. 12 is a block diagram showing a specific example of the case of FIG. 8 where detection of the display characteristic is executed by another method;

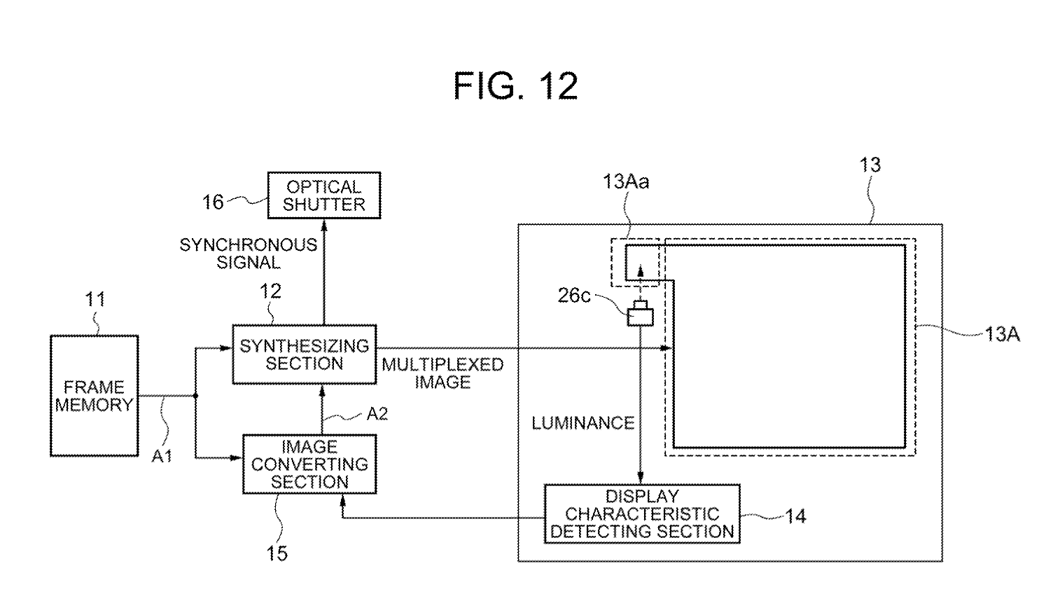

FIG. 13 is a block diagram showing a specific example of the case of FIG. 8 where detection of the display characteristic is executed by still another method;

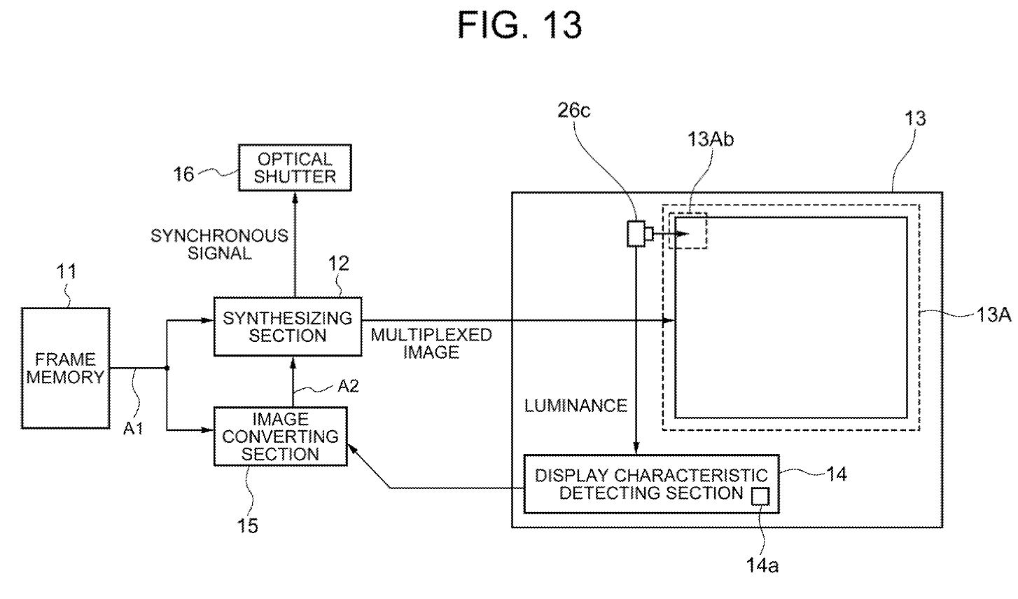

FIG. 14 is a block diagram showing a specific example of the case of FIG. 8 where detection of the display characteristic is executed by using a temperature sensor;

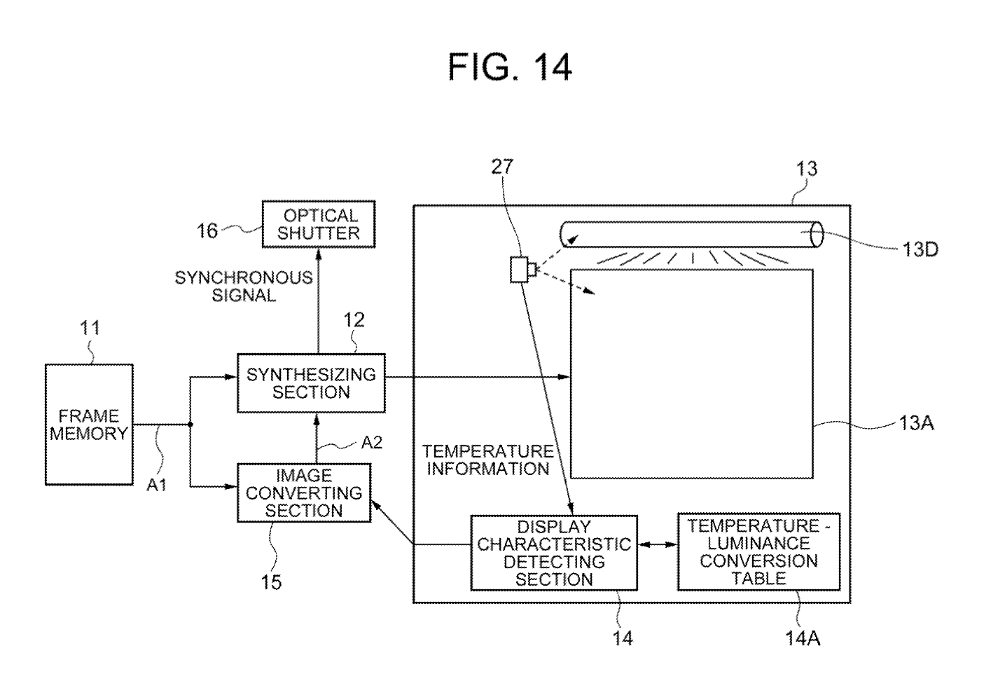

FIG. 15 is a chart showing an example of a data conversion table that is used when detecting the display characteristic in the case of FIG. 14; and

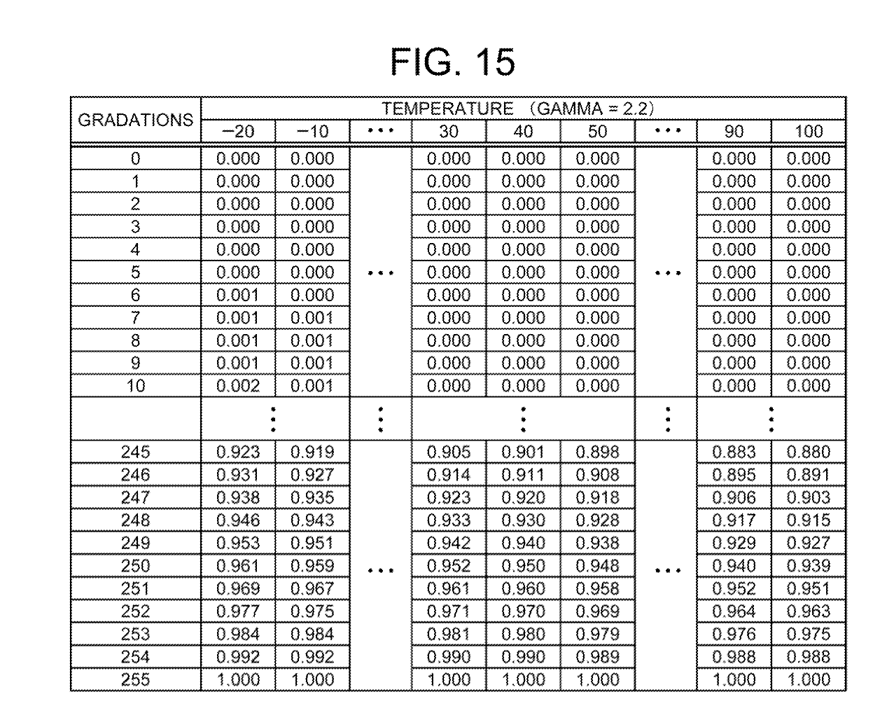

FIG. 16 is an explanatory diagram showing an example of a related technique of the preset invention.

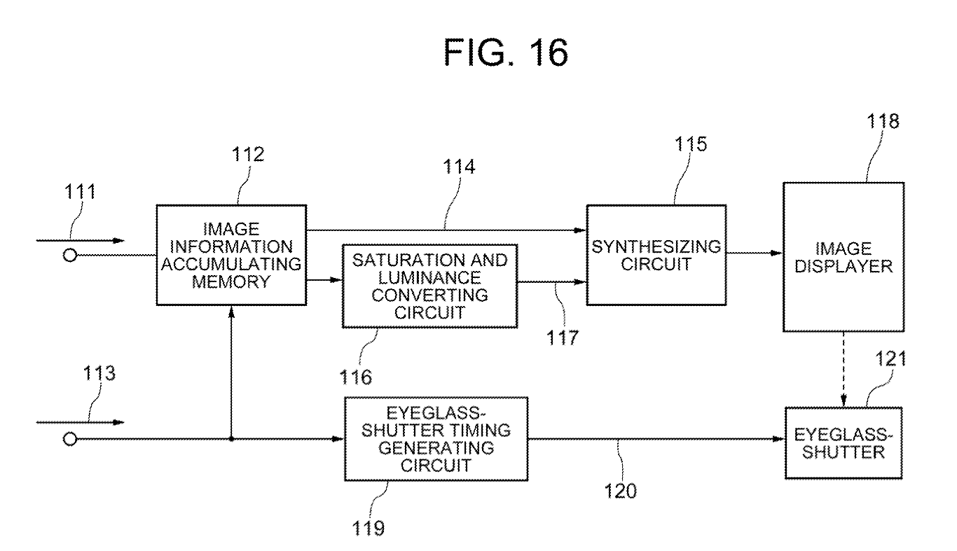

### REFERENCE NUMERALS

11 Frame memory (image memory)

12 Synthesizing section (image synthesizing section)

13 Display device main body

13A Image display section

13Aa Test image display section

14 Display characteristic detecting section

14A Conversion table (temperature-luminance conversion table)

14a, 14b, 14c, 14d Memory

15 Image converting section

16 Optical shutter

17 Frame memory (for storing public image)

18 Projecting section

26, 26A, 16B, 26C Luminance sensor

27 Temperature sensor

What is claimed is:

1-37. (canceled)

38. An image display device having a function which displays an inputted first image only to a specific user, the image display device comprising:
an image synthesizing section which time-multiplexes the first image and a second image different from the first image;
an image display section which displays the time-multiplexed image;
a display characteristic detecting section which detects a display characteristic of the image display section;
an image converting section which converts the first image to the second image based on the detected display characteristic; and
an optical shutter which transmits light when the first image is displayed on the image display section upon receiving a signal from the image synthesizing section.

39. The image display device as claimed in claim 38, wherein when adding luminance values of each pixel of the first image and luminance values of each pixel of the second image based on the detected display characteristic, the image converting section generates the second image as an image that has no correlation to the first image.

40. The image display device as claimed in claim 38, wherein:
the image synthesizing section time-multiplexes a third image with the first image and the second image; and
the optical shutter transmits light when the first image is displayed on the image display section, and blocks light when the second image is displayed on the image display section.

41. The image display device as claimed in claim 38, wherein when luminance of each pixel displayed on the image display section can be expressed as I=L×A(γ) (I is the luminance of the image displayed on the image display section, L is maximum luminance that can be displayed on the image display section, A is a signal value of the pixel, and γ is a gamma value according to the display characteristic of the image display section), the image converting section calculates each signal value A′ of the second image by using a following equation based on the display characteristic obtained by the display characteristic detecting section.
A′=(1/A(γ))(1/γ)

42. The image display device as claimed in claim 38, wherein the display characteristic detecting section detects the display characteristic of the image display section via an input device which changes the display characteristic of the image display section.

43. The image display device as claimed in claim 42, wherein the display characteristic detecting section transmits a gamma value corresponding to the display characteristic acquired via the input device to the image converting section; and
the image converting section converts the first image to the second image based on the gamma value.

44. The image display device as claimed in claim 42, wherein the display characteristic detecting section transmits conversion table data for converting pixel values of the first image to pixel values of the second image, which corresponds to the display characteristic acquired via the input device, to the image converting section; and
the image converting section converts the first image to the second image based on values of the conversion table.

45. The image display device as claimed in claim 38, wherein the display characteristic detecting section detects the display characteristic of the image display section by acquiring luminance of a test image displayed on the image display section by using a luminance sensor.

46. The image display device as claimed in claim 45, comprising an image projecting section to which a synthesized multiplexed image is projected, wherein:
the test image is displayed on the image projecting section in a part that does not disturb viewing; and
the luminance sensor acquires the luminance of the test image by synchronizing with the display of the test image.

47. The image display device as claimed in claim 45, comprising an image projecting section to which a synthesized multiplexed image is projected, wherein:
the test image is displayed as a test image for acquiring the display characteristic on a part or a whole part of the image projecting section;
the optical shutter blocks light by synchronizing with the display of the test image; and
the luminance sensor acquires the luminance of the test image by synchronizing with the display of the test image.

48. The image display device as claimed in claim 46, wherein:
at least two pieces of the test images are displayed in short time during which the images are not perceived by human eyes; and
total luminance of the two pieces of the test images is equal to a maximum luminance value that can be displayed on the image display section.

49. A computer readable recording medium storing an image display program which executes a control for displaying an inputted first image only to a specific user, the program causing a computer to execute:
an image synthesizing function which time-multiplexes the first image and a second image different from the first image;
an image display function which displays the time-multiplexed image;
a display characteristic detecting function which detects a display characteristic of the image display section;
an image converting function which converts the first image to the second image based on the detected display characteristic; and
an optical shutter operating function which transmits light when the first image is displayed on the image display section upon receiving a signal from the image synthesizing section.

50. The computer readable recording medium storing the image display program as claimed in claim 49, wherein
the image converting function generates the second image in such a manner that an image obtained as a result of mutually adding luminance values of pixels corresponding to those of the first image becomes another image that has no correlation to the first image as a whole when generating the second image that is generated based on the display characteristic of the image display section.

51. The computer readable recording medium storing the image display program as claimed in claim 49, wherein when luminance of each pixel displayed on the image display section can be expressed as I=L×A(γ) (I is the luminance of the image displayed on the image display section, L is maximum luminance that can be displayed on the image display section, A is a signal value of the pixel, and γ is a gamma value according to the display characteristic of the image display section), the image converting function calculates each pixel value A′ of the second image by using a following equation based on the display characteristic of the image display section obtained by the display characteristic detecting section.
A′=(1−A(γ))(1−γ)

52. The computer readable recording medium storing the image display program as claimed in claim 49, wherein
when time-multiplexing the first image with a second image that is obtained by applying prescribed conversion to the first image, the image synthesizing function time-multiplexes a third image that is inputted from outside accordingly.

53. The computer readable recording medium storing the image display program as claimed in claim 49, wherein
the image converting function fetches the display characteristic inputted from outside for the image display section as the display characteristic required for generating the second image.

54. The computer readable recording medium storing the image display program as claimed in claim 49, wherein
the image converting function includes: characteristic information acquiring processing which fetches characteristic information for specifying the display characteristic of the image display section inputted from outside; and conversion table data extracting processing which extracts conversion table data corresponding to the characteristic information from a memory that is prepared in advance and fetches the data as the display characteristic required when generating the second image.

55. The computer readable recording medium storing the image display program as claimed in claim 49, wherein
the image converting function includes: luminance detecting processing which detects luminance of each pixel via a luminance sensor from a test image that is displayed on a part of the image display section; and display characteristic specifying processing which detects and specifies the display characteristic of the image display section based on the detected luminance.

56. The computer readable recording medium storing the image display program as claimed in claim 49, wherein
the image converting function includes: processing which detects luminance of a test image projected on a part or a whole part of a multiplexed image displaying screen by synchronizing with projecting timing of the test image; and processing which specifies the display characteristic of the image display section based on the detected luminance of the test image.

57. An image display device having a function which displays an inputted first image only to a specific user, the image display device comprising:
image synthesizing means for time-multiplexing the first image and a second image different from the first image;
image display means for displaying the time-multiplexed image;
display characteristic detecting means for detecting a display characteristic of the image display means;
image converting means for converting the first image to the second image based on the detected display characteristic; and
optical shutter means for transmitting light when the first image is displayed on the image display means upon receiving a signal from the image synthesizing means.
